(19) United States
(12) Patent Application Publication
(10) Pub. No.: US 2025/0283297 A1
(43) Pub. Date: Sep. 11, 2025

(54) WORK IMPLEMENT FORCE CONTROL

(71) Applicant: Doosan Bobcat North America Inc., West Fargo, ND (US)

(72) Inventors: John Hoaby, Lisbon, ND (US); Thomas M. Sagaser, Mandan, ND (US)

(21) Appl. No.: 19/072,431

(22) Filed: Mar. 6, 2025

Related U.S. Application Data
(60) Provisional application No. 63/562,481, filed on Mar. 7, 2024.

(51) Int. Cl. E02F 3/43; E02F 3/413

(52) U.S. Cl. CPC E02F 3/435; E02F 3/413

(57) ABSTRACT

A power machine includes a lift arm structure including a boom, an arm pivotally coupled to the boom and a work implement pivotally coupled to the arm. The work implement is configured to grip a material. A work implement actuator is configured to pivot the work implement relative to the arm and apply pressure to the material. At least one sensor is configured to provide a measurement for calculating a position angle of the work implement relative to the arm. A controller is configured to maintain an optimal pressure on the work implement actuator based on the position angle of the work implement relative to the arm and based on a characteristic of the material.

### CROSS-REFERENCE RELATED APPLICATION(S)

This application claims the benefit of U.S. provisional application No. 63/562,481, filed on 7 Mar. 2024, the content of which is hereby incorporated by reference in its entirety.

### BACKGROUND

Power machines, for the purposes of this disclosure, include any type of machine that generates power for the purpose of accomplishing a particular task or a variety of tasks. One type of power machine is a work vehicle. Work vehicles are generally self-propelled vehicles that have a work device, such as a lift arm (although some work vehicles can have other work devices) that can be manipulated to perform a work function. Work vehicles include excavators, loaders, utility vehicles, tractors, and trenchers, to name a few examples.

In a work vehicle having a lift arm structure, the lift arm structure typically has a boom-arm lift arm structure and is configured to have a bucket or other work implement attached for performing a work function such as digging. In some work vehicles, the boom-arm lift arm structure is also configured to have a powered work implement or clamp that works in coordination with the bucket or other work implement to grip, lift, move and place heavy debris.

The discussion above is merely provided for general background information and is not intended to be used as an aid in determining the scope of the claimed subject matter.

### SUMMARY

A power machine includes a lift arm structure having a boom, an arm pivotally coupled to the boom and a work implement pivotally coupled to the arm. The work implement is configured to grip a material. A work implement actuator is configured to pivot the work implement relative to the arm and apply pressure to the material. At least one sensor is configured to provide a measurement for calculating a position angle of the work implement relative to the arm. A controller is configured to maintain an optimal pressure on the work implement actuator based on the position angle of the work implement relative to the arm and based on a characteristic of the material.

A method of automatically controlling the force provided to a work implement actuator includes calculating a position angle of a work implement relative to an arm of a lift arm structure. The work implement is pivotally coupled to the arm. An optimal pressure is determined based on an input indicative of a characteristic of the material and the position angle of the work implement relative to the arm. A pressure applied to the work implement actuator is increased to the optimal pressure when the pressure being applied is less than the optimal pressure and the pressure applied to the work implement actuator is decreased to the optimal pressure when the pressure being applied is greater than the optimal pressure.

An excavator includes a house having an operator station that is rotatably coupled to an undercarriage that has tractive elements. A lift arm structure is coupled to the house and includes a boom, an arm pivotally coupled to the boom and a work implement pivotally coupled to the arm. The work implement is configured to grip material. A work implement actuator is configured to pivot the work implement relative to the arm. At least one sensor is configured to provide a measurement for calculating a position angle of the work implement relative to the arm. A controller is configured to maintain a pressure on the work implement actuator based on the position angle of the work implement and a characteristic of the material that is related to a weight of the material.

This Summary and the Abstract are provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating functional systems of a representative power machine on which embodiments of the present disclosure can be practiced.

FIG. 2 is a front left perspective view of a representative power machine in the form of an excavator on which the disclosed embodiments can be practiced.

FIG. 3 is a rear right perspective view of the excavator of FIG. 2.

FIG. 4 is a perspective view of portions of a lift arm structure including a boom, arm, bucket and clamp in a first position in accordance with an exemplary embodiment.

FIG. 5 is a perspective view of portions of the lift arm structure of FIG. 4 including arm, bucket and clamp in a second position in accordance with an exemplary embodiment.

FIG. 6 illustrates a block diagram of a control system of a power machine for providing automatic force control on a clamp implement according to exemplary embodiments.

FIG. 7 illustrates a flowchart of a method of a controller automatically controlling a force on an object or actively maintaining pressure provided to a clamp actuator according to an embodiment.

FIG. 8 is an exemplary schematic diagram of an arm and clamp illustrating an exemplary point of contact selected for determining a force on an object according to one embodiment.

FIG. 9 illustrates a graph illustrating an exemplary pressure curve for a specific force according to an embodiment.

FIG. 10 illustrates an exemplary schematic diagram of an arm, a bucket and a clamp to show all three elements in different relative positions when gripping, lifting, moving and placing a material or object according to an embodiment.

### DETAILED DESCRIPTION

The concepts disclosed in this discussion are described and illustrated with reference to exemplary embodiments. These concepts, however, are not limited in their application to the details of construction and the arrangement of components in the illustrative embodiments and are capable of being practiced or being carried out in various other ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

Disclosed embodiments include power machines with a lift arm structure and including a boom, an arm coupled to the boom, and a work implement coupled to the arm and operable by a work implement actuator. The work implement may be a clamp that coordinates with a second work implement and second work implement actuator, such as a bucket or grapple, to grip, lift, move and place material. One problem with a clamp is maintaining enough force on the material or object being gripped to lift, move and place but not applying so much force that the material or object breaks. Disclosed embodiments utilize a controller that is configured to automatically maintain a pressure on the clamp when gripping material or an object based on the relative position between the clamp and the arm. In additional embodiments, the controller is configured to automatically maintain a pressure on the clamp based on an approximate weight of the material or object along with the relative position between the clamp and the arm. Maintaining an angle between the bucket and the clamp can vary the amount of force applied to the material or object held between the bucket and clamp as the bucket and clamp are moved between various positions by the power machine. An advantage of this disclosure is that a force placed on the material or object is kept constant throughout movement by varying the pressure within actuators coupled to the bucket and clamp. By keeping the force constant a more secure hold can be kept on the material or object between the clamp and the bucket without applying too much force which may cause the object to break or otherwise damage the material or object being held.

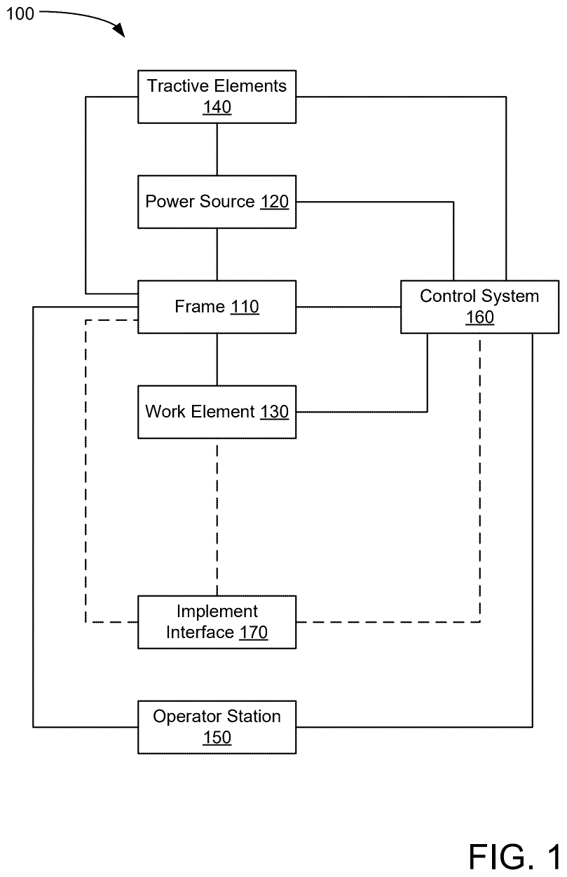

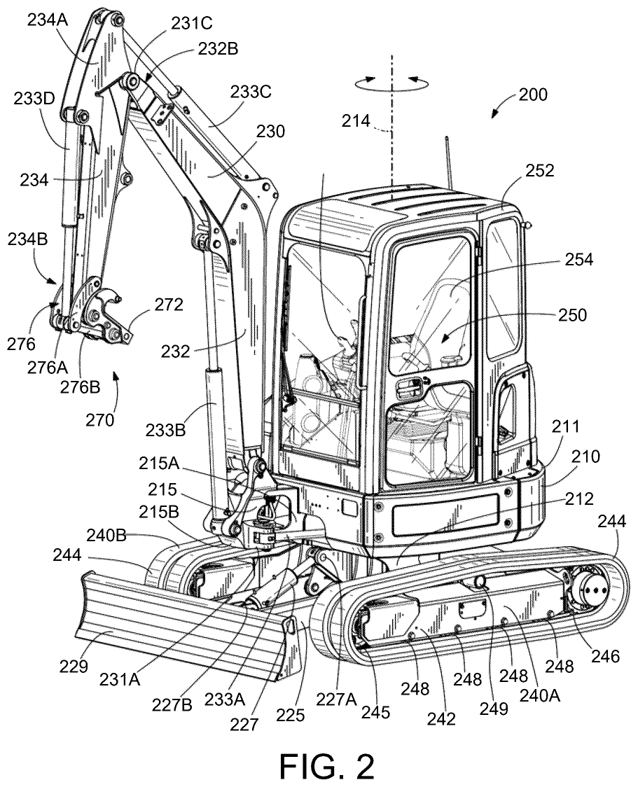

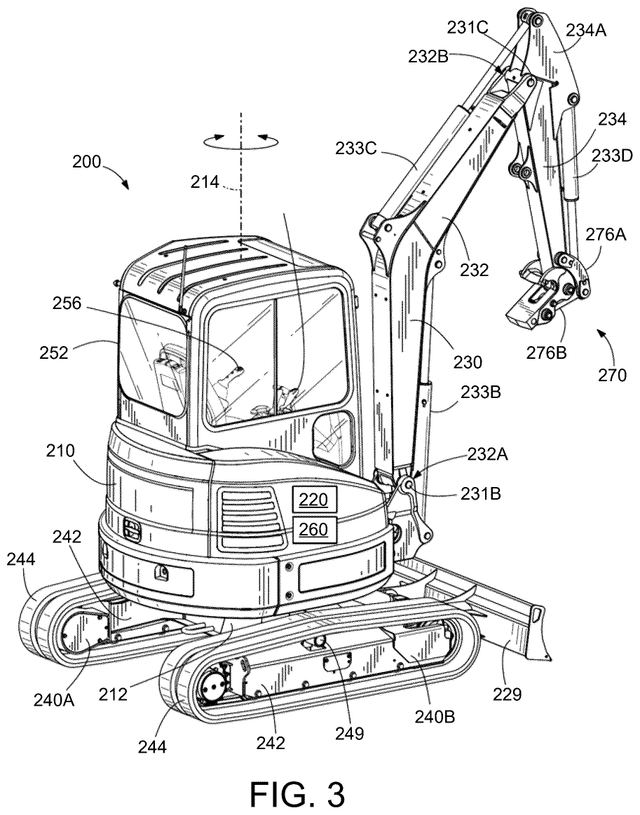

These concepts can be practiced on various power machines, as will be described below. A representative power machine on which the embodiments can be practiced is illustrated in diagram form in FIG. 1 and one example of such a power machine is illustrated in FIGS. 2-3 and described below before any embodiments are disclosed. For the sake of brevity, only one power machine is discussed. However, as mentioned above, the embodiments below can be practiced on any of a number of power machines, including power machines of different types from the representative power machine shown in FIGS. 2-3. Power machines, for the purposes of this discussion, include a frame, at least one work implement, and a power source that is capable of providing power to the work element to accomplish a work task. One type of power machine is a self-propelled work vehicle. Self-propelled work vehicles are a class of power machines that include a frame, work element, and a power source that is capable of providing power to the work element. At least one of the work elements is a motive system for moving the power machine under power. Disclosed embodiments can be utilized in different power machines and are particularly useful in power machines, such as excavators, where a lift arm structure includes a work implement. The lift arm structure may include an implement carrier to allow different implements to be attached thereto, or in the alternative, a bucket or other work implement and a clamp may be formed with or permanently attached to the lift arm structure.

Referring now to FIG. 1, a block diagram illustrates the basic systems of a power machine 100 upon which the embodiments discussed below can be advantageously incorporated and can be any of a number of different types of power machines. The block diagram of FIG. 1 identifies various systems on power machine 100 and the relationship between various components and systems. As mentioned above, at the most basic level, power machines for the purposes of this discussion include a frame, a power source, and a work element. The power machine 100 has a frame 110, a power source 120, and at least one work element 130. Because power machine 100 shown in FIG. 1 is a self-propelled work vehicle, it also has tractive elements 140, which are themselves work elements provided to move the power machine over a support surface and an operator station 150 that provides an operating position for controlling the work elements of the power machine. A control system 160 is provided to interact with the other systems to perform various work tasks at least in part in response to control signals provided by an operator.

Certain work vehicles have work elements that are capable of performing a dedicated task. For example, some work vehicles have a lift arm to which an implement such as a bucket is attached such as by a pinning arrangement. The work element, i.e., the lift arm can be manipulated to position the implement for the purpose of performing the task. The implement, in some instances can be positioned relative to the work element, such as by rotating a bucket relative to a lift arm, to further position the implement. Under normal operation of such a work vehicle, the bucket is intended to be attached and under use. Such work vehicles may be able to accept other implements by disassembling the implement/work element combination and reassembling another implement in place of the original bucket. Other work vehicles, however, are intended to be used with a wide variety of implements and have an implement interface such as implement interface 170 shown in FIG. 1. At its most basic, implement interface 170 is a connection mechanism between the frame 110 or a work element 130 and an implement, which can be as simple as a connection point for attaching an implement directly to the frame 110 or a work element 130 or more complex, as discussed below.

On some power machines, implement interface 170 can include an implement carrier, which is a physical structure movably attached to a work element. The implement carrier has engagement features and locking features to accept and secure any of a number of implements to the work element. One characteristic of such an implement carrier is that once an implement is attached to it, it is fixed to the implement (i.e. not movable with respect to the implement) and when the implement carrier is moved with respect to the work element, the implement moves with the implement carrier. The term implement carrier is not merely a pivotal connection point, but rather a dedicated device specifically intended to accept and be secured to various different implements. The implement carrier itself is mountable to a work element 130 such as a lift arm or the frame 110. Implement interface 170 can also include one or more power sources for providing power to one or more work elements on an implement. Some power machines can have a plurality of work element with implement interfaces, each of which may, but need not, have an implement carrier for receiving implements. Some other power machines can have a work element with a plurality of implement interfaces so that a single work element can accept a plurality of implements simultaneously. Each of these implement interfaces can, but need not, have an implement carrier.

Frame 110 includes a physical structure that can support various other components that are attached thereto or positioned thereon. The frame 110 can include any number of individual components. Some power machines have frames that are rigid. That is, no part of the frame is movable with respect to another part of the frame. Other power machines have at least one portion that is capable of moving with respect to another portion of the frame. For example, excavators can have an upper frame portion that rotates with respect to a lower frame portion. Other work vehicles have articulated frames such that one portion of the frame pivots with respect to another portion for accomplishing steering functions.

Frame 110 supports the power source 120, which is capable of providing power to one or more work elements 130 including the one or more tractive elements 140, as well as, in some instances, providing power for use by an attached implement via implement interface 170. Power from the power source 120 can be provided directly to any of the work elements 130, tractive elements 140, and implement interfaces 170. Alternatively, power from the power source 120 can be provided to a control system 160, which in turn selectively provides power to the elements to perform a work function. Power sources for power machines typically include an engine such as an internal combustion engine and a power conversion system such as a mechanical transmission or a hydraulic system that is capable of converting the output from an engine into a form of power that is usable by a work element. Other types of power sources can be incorporated into power machines, including electrical sources or a combination of power sources, known generally as hybrid power sources.

FIG. 1 shows a single work element designated as work element 130, but various power machines can have any number of work elements. Work elements are typically attached to the frame of the power machine and movable with respect to the frame when performing a work task. In addition, tractive elements 140 are a special case of work element in that their work function is generally to move the power machine 100 over a support surface. Tractive elements 140 are shown separate from the work element 130 because many power machines have additional work elements besides tractive elements, although that is not always the case. Power machines can have any number of tractive elements, some or all of which can receive power from the power source 120 to propel the power machine 100. Tractive elements can be, for example, wheels attached to an axle, track assemblies, and the like. Tractive elements can be rigidly mounted to the frame such that movement of the tractive element is limited to rotation about an axle or steerably mounted to the frame to accomplish steering by pivoting the tractive element with respect to the frame.

Power machine 100 includes an operator station 150, which provides a position from which an operator can control operation of the power machine. In some power machines, the operator station 150 is defined by an enclosed or partially enclosed cab. Some power machines on which the disclosed embodiments may be practiced may not have a cab or an operator compartment of the type described above. For example, a walk behind loader may not have a cab or an operator compartment, but rather an operating position that serves as an operator station from which the power machine is properly operated. More broadly, power machines other than work vehicles may have operator stations that are not necessarily similar to the operating positions and operator compartments referenced above. Further, some power machines such as power machine 100 and others, whether or not they have operator compartments or operator positions, may be capable of being operated remotely (i.e. from a remotely located operator station) instead of or in addition to an operator station adjacent or on the power machine. This can include applications where at least some of the operator controlled functions of the power machine can be operated from an operating position associated with an implement that is coupled to the power machine. Alternatively, with some power machines, a remote control device can be provided (i.e. remote from both of the power machine and any implement to which is it coupled) that is capable of controlling at least some of the operator controlled functions on the power machine.

FIGS. 2-3 illustrate an excavator 200, which is one particular example of a power machine of the type illustrated in FIG. 1, on which the disclosed embodiments can be employed. Unless specifically noted otherwise, embodiments disclosed below can be practiced on a variety of power machines, with the excavator 200 being only one of those power machines. Excavator 200 is described below for illustrative purposes. Not every excavator or power machine on which the illustrative embodiments can be practiced need have all of the features or be limited to the features that excavator 200 has. Excavator 200 has a frame 210 that supports and encloses a power system 220 (represented in FIGS. 2-3 as a block, as the actual power system is enclosed within the frame 210). The power system 220 includes an engine that provides a power output to a hydraulic system. The hydraulic system acts as a power conversion system that includes one or more hydraulic pumps for selectively providing pressurized hydraulic fluid to actuators that are operably coupled to work elements in response to signals provided by operator input devices. The hydraulic system also includes a control valve system that selectively provides pressurized hydraulic fluid to actuators in response to signals provided by operator input devices. The excavator 200 includes a plurality of work elements in the form of a first lift arm structure 230 and a second lift arm structure 225 (not all excavators have a second lift arm structure). In addition, excavator 200, being a work vehicle, includes a pair of tractive elements in the form of left and right track assemblies 240A and 240B, which are disposed on opposing sides of the frame 210.

An operator compartment 250 is defined in part by a cab 252, which is mounted on the frame 210. The cab 252 shown on excavator 200 is an enclosed structure, but other operator compartments need not be enclosed. For example, some excavators have a canopy that provides a roof but is not enclosed A control system, shown as block 260 is provided for controlling the various work elements. Control system 260 includes operator input devices, which interact with the power system 220 to selectively provide power signals to actuators to control work functions on the excavator 200.

Frame 210 includes an upper frame or house 211 that is pivotally mounted on a lower frame or undercarriage 212 via a swivel joint. The swivel joint includes a bearing, a ring gear, and a slew motor with a pinion gear (not pictured) that engages the ring gear to swivel the machine. The slew motor receives a power signal from the control system 260 to rotate the house 211 with respect to the undercarriage 212. House 211 is capable of unlimited rotation about a swivel axis 214 under power with respect to the undercarriage 212 in response to manipulation of an input device by an operator. Hydraulic conduits are fed through the swivel joint via a hydraulic swivel to provide pressurized hydraulic fluid to the tractive elements and one or more work elements such as lift arm 225 that are operably coupled to the undercarriage 212.

The first lift arm structure 230 is mounted to the house 211 via a swing mount 215. (Some excavators do not have a swing mount of the type described here.) The first lift arm structure 230 is a boom-arm lift arm of the type that is generally employed on excavators although certain features of this lift arm structure may be unique to the lift arm illustrated in FIGS. 2-3. The swing mount 215 includes a frame portion 215A and a lift arm portion 215B that is rotationally mounted to the frame portion 215A at a mounting frame pivot 231A. A swing actuator 233A is coupled to the house 211 and the lift arm portion 215B of the mount. Actuation of the swing actuator 233A causes the lift arm structure 230 to pivot or swing about an axis that extends longitudinally through the mounting frame pivot 231A.

The first lift arm structure 230 includes a first portion, known generally as a boom 232 and a second portion known as an arm or a dipper 234. The boom 232 is pivotally attached on a first end 232A to mount 215 at boom pivot mount 231B. A boom actuator 233B is attached to the mount 215 and the boom 232. Actuation of the boom actuator 233B causes the boom 232 to pivot about the boom pivot mount 231B, which effectively causes a second end 232B of the boom to be raised and lowered with respect to the house 211. A first end 234A of the arm 234 is pivotally attached to the second end 232B of the boom 232 at an arm mount pivot 231C. An arm actuator 233C is attached to the boom 232 and the arm 234. Actuation of the arm actuator 233C causes the arm to pivot about the arm mount pivot 231C. Each of the swing actuator 233A, the boom actuator 233B, and the arm actuator 233C can be independently controlled in response to control signals from operator input devices.

An exemplary implement interface 270 is provided at a second end 234B of the arm 234. The implement interface 270 includes an implement carrier 272 that is capable of accepting and securing a variety of different implements to the lift arm 230. Such implements have a machine interface that is configured to be engaged with the implement carrier 272. The implement carrier 272 is pivotally mounted to the second end 234B of the arm 234. An implement carrier actuator 233D is operably coupled to the arm 234 and a linkage assembly 276. The linkage assembly includes a first link 276A and a second link 276B. The first link 276A is pivotally mounted to the arm 234 and the implement carrier actuator 233D. The second link 276B is pivotally mounted to the implement carrier 272 and the first link 276A. The linkage assembly 276 is provided to allow the implement carrier 272 to pivot about the arm 234 when the implement carrier actuator 233D is actuated.

The implement interface 270 also includes an implement power source (not shown in FIGS. 2-3) available for connection to an implement on the lift arm structure 230. The implement power source includes pressurized hydraulic fluid port to which an implement can be coupled. The pressurized hydraulic fluid port selectively provides pressurized hydraulic fluid for powering one or more functions or actuators on an implement. The implement power source can also include an electrical power source for powering electrical actuators and/or an electronic controller on an implement. The electrical power source can also include electrical conduits that are in communication with a data bus on the excavator 200 to allow communication between a controller on an implement and electronic devices on the excavator 200. It should be noted that the specific implement power source on excavator 200 does not include an electrical power source.

The lower frame 212 supports and has attached to it a pair of tractive elements 240, identified in FIGS. 2-3 as left track drive assembly 240A and right track drive assembly 240B. Each of the tractive elements 240 has a track frame 242 that is coupled to the lower frame 212. The track frame 242 supports and is surrounded by an endless track 244, which rotates under power to propel the excavator 200 over a support surface. Various elements are coupled to or otherwise supported by the track 242 for engaging and supporting the track 244 and cause it to rotate about the track frame. For example, a sprocket 246 is supported by the track frame 242 and engages the endless track 244 to cause the endless track to rotate about the track frame. An idler 245 is held against the track 244 by a tensioner (not shown) to maintain proper tension on the track. The track frame 242 also supports a plurality of rollers 248, which engage the track and, through the track, the support surface to support and distribute the weight of the excavator 200. An upper track guide 249 is provided for providing tension on track 244 and prevent the track from rubbing on track frame 242.

A second, or lower lift arm 225 is pivotally attached to the lower frame 212. A lower lift arm actuator 227 is pivotally coupled to the lower frame 212 at a first end 227A and to the lower lift arm 225 at a second end 227B. The lower lift arm 225 is configured to carry a lower implement 229. The lower implement 229 can be rigidly fixed to the lower lift arm 225 such that it is integral to the lift arm. Alternatively, the lower implement can be pivotally attached to the lower lift arm via an implement interface, which in some embodiments can include an implement carrier of the type described above. Lower lift arms with implement interfaces can accept and secure various different types of implements thereto. Actuation of the lower lift arm actuator 227, in response to operator input, causes the lower lift arm 225 to pivot with respect to the lower frame 212, thereby raising and lowering the lower implement 229.

Upper frame portion 211 supports cab 252, which defines, at least in part, operator compartment or station 250. A seat 254 is provided within cab 252 in which an operator can be seated while operating the excavator. While sitting in the seat 254, an operator will have access to a plurality of operator input devices 256 that the operator can manipulate to control various work functions, such as manipulating the lift arm 230, the lower lift arm 225, the traction system 240, pivoting the house 211, the tractive elements 240, and so forth.

Excavator 200 provides a variety of different operator input devices 256 to control various functions. For example, hydraulic joysticks are provided to control the lift arm 230, and swiveling of the house 211 of the excavator. Foot pedals with attached levers are provided for controlling travel and lift arm swing. Electrical switches are located on the joysticks for controlling the providing of power to an implement attached to the implement carrier 272. Other types of operator inputs that can be used in excavator 200 and other excavators and power machines include, but are not limited to, switches, buttons, knobs, levers, variable sliders and the like. The specific control examples provided above are exemplary in nature and not intended to describe the input devices for all excavators and what they control.

Display devices are provided in the cab to give indications of information relatable to the operation of the power machines in a form that can be sensed by an operator, such as, for example audible and/or visual indications. Audible indications can be made in the form of buzzers, bells, and the like or via verbal communication. Visual indications can be made in the form of graphs, lights, icons, gauges, alphanumeric characters, and the like. Displays can be dedicated to provide dedicated indications, such as warning lights or gauges, or dynamic to provide programmable information, including programmable display devices such as monitors of various sizes and capabilities. Display devices can provide diagnostic information, troubleshooting information, instructional information, and various other types of information that assists an operator with operation of the power machine or an implement coupled to the power machine. Other information that may be useful for an operator can also be provided.

The description of power machine 100 and excavator 200 above is provided for illustrative purposes, to provide illustrative environments on which the embodiments discussed below can be practiced. While the embodiments discussed can be practiced on a power machine such as is generally described by the power machine 100 shown in the block diagram of FIG. 1 and more particularly on an excavator such as excavator 200, unless otherwise noted, the concepts discussed below are not intended to be limited in their application to the environments specifically described above.

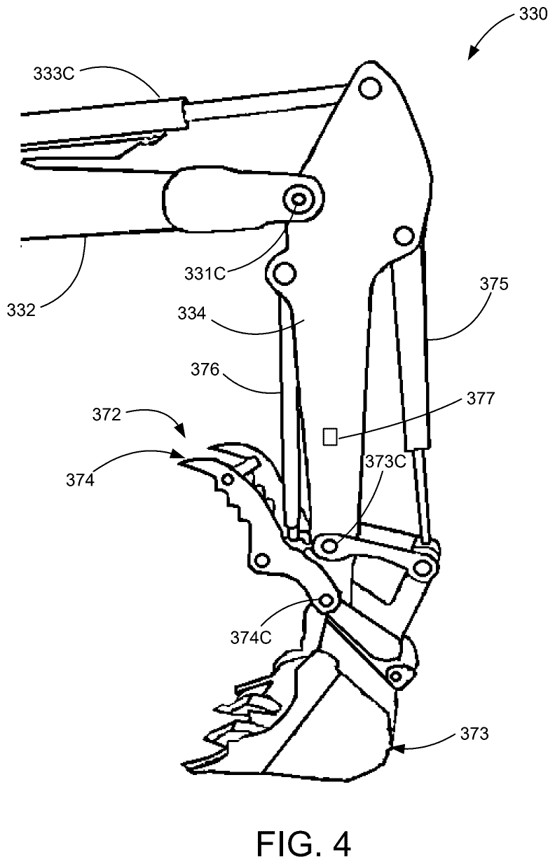

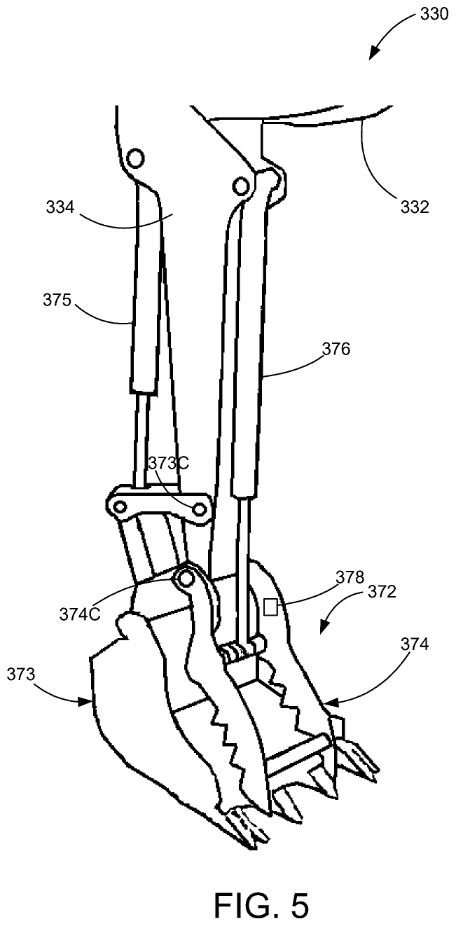

FIG. 4 is a perspective view of a portion of a lift arm structure 330 including a boom 332, arm 334, and at least one implement 372 in a first position in accordance with an exemplary embodiment, and FIG. 5 is a perspective view of the portion of lift arm structure 330 including boom 332, arm 334 and at least one implement 372 in a second position in accordance with an exemplary embodiment. It should be understood that lift arm structure 330 can be a particular embodiment of lift arm structure 230, and therefore may be part of an excavator having some or all of the above-described features of power machine 100 and excavator 200. As such, arm 334 is pivotally coupled to boom 332 at an arm mount pivot 331C. An arm actuator 333C is attached to the boom 332 and the arm 334. Actuation of the arm actuator 333C causes arm 334 to pivot about the arm mount pivot 331C. Arm actuator 333C is configured to be independently controlled in response to control signals from operator input devices.

As illustrated in FIGS. 4 and 5, the at least one implement 372 may include a bucket implement 373 and/or a clamp implement 374. A first implement or clamp/thumb implement 374 is pivotally coupled to arm 334 at a pivot 374C. Actuation of a first implement actuator or clamp actuator 376 causes first or clamp implement 374 to pivot about pivot 374C. First implement actuator or clamp actuator 376 is independently controlled in response to control signals from operator input devices. A second implement or bucket implement 373 is pivotally coupled to arm 334 at a pivot 373C. Actuation of second actuator or bucket actuator 375 causes second or bucket implement 373 to pivot about pivot 373C. Second implement actuator 375 is independently controlled in response to control signals from operator input devices. By applying pressure to a rod end (or relieving pressure from a base end) of first implement actuator 376, first or clamp implement 374 is configured into an opened position as illustrated in FIG. 4, and by applying pressure to the base end (or relieving pressure from the rod end) of first implement actuator 376, first or clamp implement 374 is configured into a closed position as illustrated in FIG. 5. Although not specifically illustrated in FIGS. 4 and 5, by applying pressure to a rod end (or relieving pressure from a base end) of second implement actuator 375, second or bucket implement 373 pivotally moves about pivot 373C. To pick up material or an object using coordinated work between bucket implement 373 and clamp implement 374 requires applying enough pressure or force on the material or object to grip, lift, move and place the material or object, but not enough to break the material. For example, applying a single pressure using the first implement actuator or clamp actuator 376 throughout the entire process of clamp implement 374 and bucket implement 373 gripping, lifting and moving material can cause the material or object to break or be dropped due to the differing amounts of pressure needing to be applied by the actuator 376 on clamp implement 374 against bucket implement 373 at any given position.

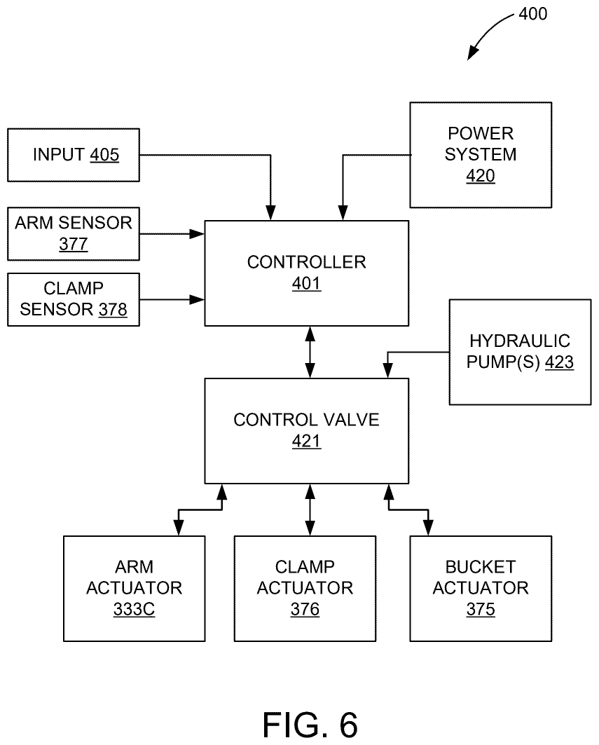

FIG. 6 illustrates a block diagram of a control system 400 of a power machine for providing automatic force control on clamp implement 374 according to exemplary embodiments. Control system 400 includes a controller 401 configured to receive input signals or data, and responsively control a control valve 421 to separately and simultaneously control the coupling of pressurized hydraulic fluid from one or more hydraulic pumps 423 of the above-discussed power conversion system, to a work actuator, such as arm actuator 333C, clamp actuator 376 and bucket actuator 375. Controller 401 is configured to provide signals to control valve 421 to control the general movement of arm actuator 333C, clamp actuator 376 and bucket actuator 375. In order to perform material or object handling operations, such as gripping, lifting, moving and placing material, a clamp implement, such as clamp implement 374 powered by clamp actuator 376, may move toward or away from a bucket implement, such as bucket implement 373, and in time with the bucket implement to maintain a clamp force against the bucket implement. Likewise to perform material or object handling operations, such as gripping, lifting, moving and placing material, the bucket implement 373 may move toward or away from the clamp implement 374 and in time with the clamp implement to maintain the clamp force.

In either operation, controller 401 is configured to provide automatic force control to clamp actuator 376 and therefore clamp implement 374 so that the material being gripped, lifted, moved and placed does not get crushed, broken or dropped. In particular, controller 401 is configured to automatically provide additive pressure to clamp actuator 376 by way of increasing pressure on a base end of clamp actuator 376 when the pressure is determined to be too low to keep the material gripped. Likewise, controller 401 is configured to automatically provide pressure relief to clamp actuator 401 by way of decreasing pressure on the base end of clamp actuator 376 when the pressure is determined to be too high, which may crush or break the material.

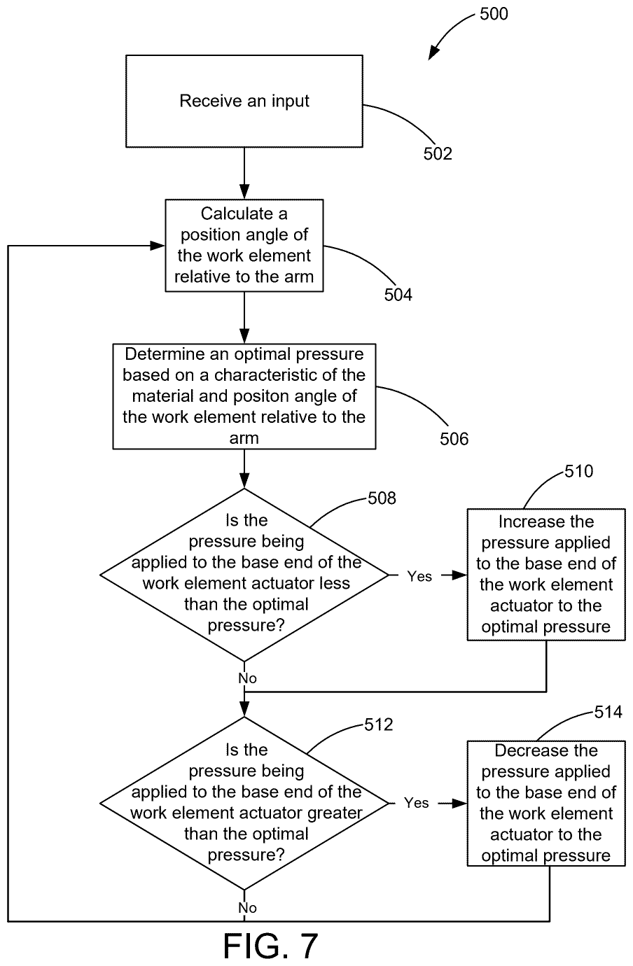

FIG. 7 illustrates a flowchart of a method of controller 401 automatically controlling the force on material or an object or actively maintaining pressure provided to clamp actuator 376 according to an embodiment. Although not specifically illustrated, the method of providing automatic force control illustrated in FIG. 7 may need to be enabled in order to actively maintain pressure. Under one embodiment, an operator may be moving a bucket, such as bucket implement 373, toward a clamp, such as clamp implement 374, and material or an object is being pinched between the clamp implement and the bucket implement. This action will cause pressure to build in clamp actuator 376 to a trigger point. Once the trigger point is reached, control system 400 is enabled to actively maintain pressure.

Under another embodiment, a detent mode of clamp implement 374 may be the trigger to enable control system 400 to actively maintain pressure. In this instance, an operator may use an operator input, such as a joystick, to move clamp implement 374 to contact the material or object and in turn pressure begins to build in clamp actuator 376 to a trigger point. Once the trigger point is reached, control system 400 is enabled to actively maintain pressure within the actuator. The trigger point can be used to maintain a desired pressure within the actuator. The desired pressure within the actuator maintains a force exerted on the material or object by the clamp and bucket.

Under yet another embodiment, while maintaining a clamp force on the material and against the bucket in either of the embodiments described in the above paragraphs, the operator may move bucket implement 373 in an upwards or downwards scooping motion and thereby clamp implement 374 is configured to follow bucket implement 373 to maintain a clamp force on the material. In this embodiment, the operator may try to move bucket implement 373 too quickly and clamp implement 374 will not have enough hydraulic flow to maintain the clamp force on the material or have too much hydraulic flow and crush the material. Therefore, under this embodiment, speed of movement of the bucket implement 373 is limited to allow clamp implement 374 time to increase hydraulic flow to maintain the clamp force or time to dump hydraulic pressure to decrease the clamp force. For example, the speed of bucket implement 373 may be limited to 50% of the normal speed of bucket implement 373. However, the amount of speed limiting may vary including being limited to 25% to 50% or limited to 50% to 75%.

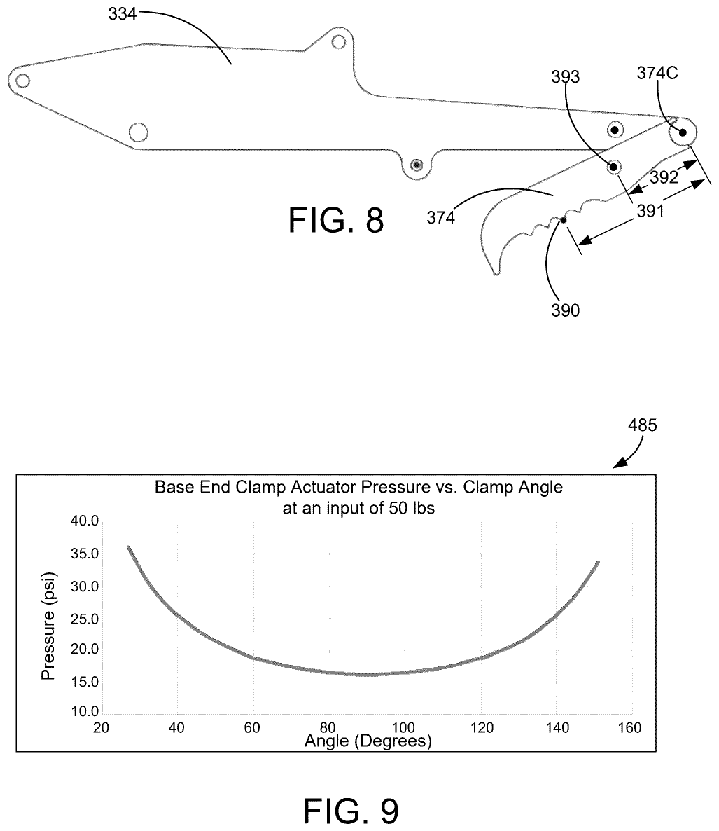

FIG. 8 is an exemplary schematic diagram of arm 334 and clamp 374 illustrating an exemplary point of contact 390 selected for determining a force on an object according to one embodiment. Based on point of contact 390, other values to be determined include an overall thumb length 391 from pivot 374C to point of contact 390, a thumb length 392 from pivot 374C to cylinder pivot 393, an angle of clamp 374 to arm 334 and a user or operator determined force setting. From these values, and under one embodiment, a base pressure in clamp actuator 376 may be determined. New base pressures in clamp actuator 376 are determined and changed as the angle of thumb 374 to arm 334 changes during the action of moving and placing the object. In another embodiment, the base pressures in the clamp actuator can be determined based on the angle of the thumb to bucket as well as the angle of the thumb to the arm during the action of moving and placing the object.

With reference back to FIG. 7, at block 502, controller 401 receives an input. For example, the input may be indicative of a characteristic of a material or object that is to be gripped, lifted, moved and placed. Under one embodiment and as illustrated in FIG. 6, the input may be supplied to controller 401 by input 405, which may be an operator input using operator control devices such as those in operator station 150 discussed above. Regardless of how input 405 functions, input 405 may be indicative of a characteristic of the material or object to which the work implement, such as clamp implement 374 is to grip, lift, move and place. For example, the characteristic may be related to the material or object's weight or density. In other embodiments and as illustrated in FIG. 6, the characteristic of a material or object may be indicative of a type of material or object to which the work implement is to grip, lift, move, and place. The type of material or object could be any type moved by a work machine as described herein but can include a pipe, tree, concrete block, brush, conduit, or other material or objects moved by an operator of a work machine. In yet other embodiments, the input may be an amount of force selected or desired by the user before gripping the material or object between the clamp and bucket or an amount of force selected or desired by the user after the material or object is gripped. In some embodiments, the input is a selectable pressure curve that varies the pressure within the actuator for each of the different position angles of clamp. The different selectable pressure curves for a specific force or for a specific type of material or object to be grasped between the clamp and bucket may be stored on the controller.

FIG. 9 illustrates a graph 485 illustrating an example of a selectable pressure curve for a specific force of 50 pounds according to an embodiment. At 50 pounds of input and at position angle 381 (˜124 degrees), the optimal pressure needed on the base end of the clamp actuator 376 is about 20 psi. Likewise, at 50 pounds of input and at position angle 383 (˜27 degrees), the optimal pressure needed on the base end of the clamp actuator 376 is about 36 psi. As can be determined from the curve in graph 485, the minimum amount of optimal pressure of the actuator is when clamp 374 is oriented perpendicular to or at ninety degrees relative to arm 334 and the maximum amount of optimal pressure is when the angle of clamp 374 to arm 334 is at the smallest angle and when the angle of clamp 374 to arm 334 is at the largest angle. While specific optimal pressures are described, the optimal pressure can vary based on a variety of factors as described herein, and can be specific to each combination of implements used.

With reference back to FIG. 7, at block 504, controller 401 calculates a position angle of clamp 374 relative to arm 334. As illustrated in FIGS. 4-6, controller 401 may use an arm sensor 377 (e.g., an inclinometer) to sense a position of arm 334 and may use a clamp sensor 378 (e.g., an inclinometer) to sense a position of clamp implement 374. From these two input sensors, controller 401 may determine a position angle of clamp implement 374 relative to arm 334. At block 506, controller 401 determines an optimal pressure for gripping, lifting, moving and placing the material based on a characteristic of the material, such as weight or density, and a position angle of the clamp. An optimal pressure is a pressure that will maintain a grip on the material being lifted, moved and placed without crushing or breaking the material. The method then proceeds to decision block 508. If the pressure being applied to the base end of clamp actuator 376 is less than the optimal pressure, then the pressure applied to the base end of clamp actuator 376 is increased to the optimal pressure at block 510. At decision block 512, if the pressure being applied is greater than the optimal pressure, then the pressure applied to the base end of clamp actuator 376 is decreased to the optimal pressure at block 514. The method returns to block 504 and continues to calculate the position angle of the clamp implement 374 relative to the arm 334 during the entire function of gripping, lifting, moving and placing the material so that an optimal pressure may be determined at different position angles of the clamp relative to the arm so as not to crush or drop the material. The method ends upon clamp implement 374 releasing the material after placement.

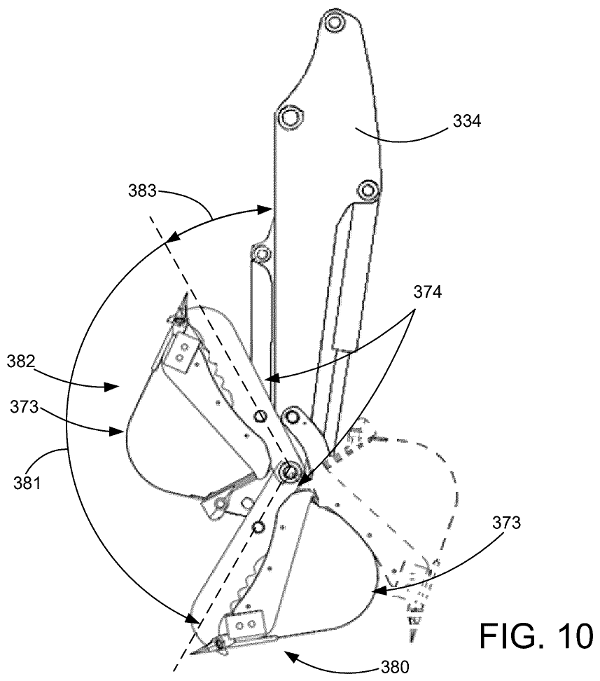

FIG. 10 illustrates an exemplary schematic diagram of arm 334, bucket 373 and clamp 374 to show all three elements in different relative positions when gripping, lifting, moving and placing a material or object according to an embodiment. In the example illustrated in FIG. 8, clamp 374 and bucket 373 are in a first position 380 where a position angle 381 of clamp 374 is calculated to be about 124 degrees relative to arm 334, and clamp 374 and bucket 375 are also in a second position 382 where a position angle 383 of clamp 374 is calculated to be about 27 degrees relative to arm 334.

Although the present invention has been described with reference to preferred embodiments, workers skilled in the art will recognize that changes may be made in form and detail without departing from the scope of the discussion.

What is claimed is:

1. A power machine comprising:
a lift arm structure including a boom, an arm pivotally coupled to the boom and a work implement pivotally coupled to the arm, wherein the work implement is configured to grip a material;
a work implement actuator configured to pivot the work implement relative to the arm and apply pressure to the material;
at least one sensor configured to provide a measurement for calculating a position angle of the work implement relative to the arm; and
a controller configured to maintain a force by maintaining an optimal pressure on the work implement actuator based on the position angle of the work implement relative to the arm and based on a characteristic of the material.

2. The power machine of claim 1, wherein the characteristic of the material is related to a weight of the material.

3. The power machine of claim 1, wherein the controller receives the characteristic of the material from an operator input.

4. The power machine of claim 1, wherein the at least one sensor comprises a first sensor coupled to the arm and a second sensor coupled to the work implement, wherein the position angle of the work implement relative to the arm is calculated from the first sensor and the second sensor.

5. The power machine of claim 1, wherein the work implement comprises a first work implement, the work implement actuator comprises a first work implement actuator and the controller is enabled to maintain an optimal pressure on the first work implement actuator when a second work implement operated by a second work implement actuator moves toward the first work implement and the material is pinched between the first work implement and the second work implement causing pressure to build in first work implement actuator to a trigger point.

6. The power machine of claim 1, wherein the controller is enabled to maintain an optimal pressure on the work implement actuator when an operator uses an operator input to move the work implement to contact the material and in turn pressure builds in the work implement actuator to a trigger point.

7. The power machine of claim 1, wherein the work implement comprises a clamp implement, the work implement actuator comprises a clamp implement actuator and the controller is configured to maintain the optimal pressure on the clamp implement actuator when a bucket implement moves the clamp implement, wherein upon an operator moving the bucket implement in this configuration the bucket implement is moved under a limited speed and the clamp implement is configured to follow the limited speed of the bucket implement to maintain the optimal pressure on the clamp implement actuator.

8. The power machine of claim 1, wherein the optimal pressure on the work implement actuator is at a minimum when the position angle of the work implement is perpendicular to the to the arm.

9. A method of automatically controlling the force provided to a work implement actuator comprising:
calculating a position angle of a work implement relative to an arm of a lift arm structure, wherein the work implement is pivotally coupled to the arm;
determining an optimal pressure based on an input indicative of a characteristic of the material and the position angle of the work implement relative to the arm; and
increasing a pressure applied to the work implement actuator to the optimal pressure when the pressure being applied is less than the optimal pressure and decreasing the pressure applied to the work implement actuator to the optimal pressure when the pressure being applied is greater than the optimal pressure.

10. The method of claim 9, further comprising receiving the characteristic of the material from an operator input.

11. The method of claim 9, wherein the characteristic of the material is related to a weight of the material.

12. The method of claim 9, further comprising receiving a measurement from a first sensor located on the arm and a measurement from a second sensor located on the work implement.

13. The method of claim 12, wherein calculating the position angle of the work implement relative to the arm of the lift arm structure comprises calculating the position angle of the work implement relative to the arm based on the measurement of the first sensor and the measurement of the second sensor.

14. The method of claim 9, wherein the steps of calculating the position angle, determining the optimal pressure and increasing or decreasing the pressure applied to the base end of the work implement actuator are repeated throughout a work implement operation of gripping, lifting, moving and placing the material.

15. The method of claim 9, wherein the work implement comprises a first work implement, the work implement actuator comprises a first work implement actuator and the steps of calculating the position angle, determining the optimal pressure and increasing or decreasing the pressure applied to the work implement actuator are enabled when a second work implement operated by a second work implement actuator moves toward the first work implement and the material is pinched between the first work implement and the second work implement causing pressure to build in first work implement actuator to a trigger point.

16. The method of claim 9, wherein the steps of calculating the position angle, determining the optimal pressure and increasing or decreasing the pressure applied to the work implement actuator are enabled when an operator uses an operator input to move the work implement to contact the material and in turn pressure builds in the work implement actuator to a trigger point.

17. An excavator comprising:
a house including an operator station that is rotatably coupled to an undercarriage having tractive elements;
a lift arm structure coupled to the house and including a boom, an arm pivotally coupled to the boom and a work implement pivotally coupled to the arm, wherein the work implement is configured to grip material;
a work implement actuator configured to pivot the work implement relative to the arm;
at least one sensor configured to provide a measurement for calculating a position angle of the work implement relative to the arm; and
a controller configured to maintain a pressure on the work implement actuator based on the position angle of the work implement and a characteristic of the material related to a weight of the material.

18. The excavator of claim 17, wherein the controller receives the characteristic of the material related to a weight of the material from an operator input.

19. The excavator of claim 17, wherein the at least one sensor comprises a first sensor coupled to the arm and a second sensor coupled to the work implement, wherein the position angle of the work implement relative to the arm is calculated from the first sensor and the second sensor.

20. The excavator of claim 17, wherein the work implement comprises a clamp implement.
